(19) United States
(12) Patent Application Publication
(10) Pub. No.: US 2017/0108026 A1
(43) Pub. Date: Apr. 20, 2017

(54) SCREW

(71) Applicant: Hui-Ju YANG, Tainan City (TW)

(72) Inventor: Hui-Ju YANG, Tainan City (TW)

(21) Appl. No.: 14/884,715

(22) Filed: Oct. 15, 2015

(51) Int. Cl. F16B 25/10; F16B 25/00

(52) U.S. Cl. CPC F16B 25/103; F16B 25/0015; F16B 25/0078

(57) ABSTRACT

The screw comprises a circular rod, a tip, a tool connecting part, a thread part, and multiple protruding ribs. The circular rod has a centerline, a tail end, and a head end. The tip is formed on the tail end. The tool connecting part is formed on the head end. The thread part helically extends from an outer surface of the tip to an outer surface of the circular rod. The multiple protruding ribs are formed on an outer surface around the tail end and disposed in multiple thread pitches of the thread part from the tip. The multiple protruding ribs straightly extend on the circular rod and are parallel to the centerline, and provide a reaming effect to reduce resistance when the tip of the screw is screwed into the workpiece. So chips are smoothly discharged from the workpiece.

### BACKGROUND OF THE INVENTION

1. Field of the Invention

The present invention relates to a screw, especially a screw for screwing wooden workpiece.

2. Description of the Prior Arts

Multiple types of screws are designed according to various applications and functions. Taking a screw for screwing wooden workpiece for example, said screw has a circular rod, a tip, a tool connecting part, and a thread. The tip is formed on a tail end of the circular rod. The tool connecting part is formed on a head end of the circular rod. The thread helically extends from an outer surface of the tip to an outer surface of the circular rod.

A hand tool or electric tool is connected to the tool connecting part of the screw by a user, and the tip of the screw is disposed towards the wooden workpiece. The screw is applied with twisting force by the hand tool or the electric tool to make the tip and the thread of the screw bore a hole and tap in the workpiece to be securely screwed with workpiece.

Though the conventional screw is an element for securely fastening the workpiece, the chips produced from the boring and tapping processes are obstructed by thermal expansion caused by the friction acting between the workpiece and the screw.

In addition, an inclined angle of a thread wall towards the tip is greater than an inclined angle of the other thread wall, so the tapping process of the screw needs a large twisting force and is laborious for user.

To overcome the shortcomings, the present invention provides a screw to mitigate or obviate the aforementioned problems.

### SUMMARY OF THE INVENTION

The main objective of the present invention is to provide a screw to eliminate obstruction of discharging chips of the conventional screw.

The screw in accordance with the present invention comprises a circular rod, a tip, a tool connecting part, a thread part, and multiple protruding ribs. The circular rod has a centerline, a tail end, and a head end. The tip is formed on the tail end of the circular rod. The tool connecting part is formed on the head end of the circular rod. The thread part helically extends from an outer surface of the tip to an outer surface of the circular rod. The multiple protruding ribs are formed on an outer surface around the tail end of the circular rod and are disposed in multiple thread pitches of the thread part from the tip. The multiple protruding ribs straightly extend on the circular rod and are parallel to the centerline of the circular rod, and a rib depth of each protruding rib is smaller than a thread depth of the thread part.

The conventional screw is applied with twisting force by the hand tool or the electric tool to make the tip and the thread of the screw bore a hole and tap in the workpiece, and the chips produced from the boring and tapping processes of the screw are discharged from the thread part to make the conventional screw securely fastened with workpiece. The screw in accordance with the present invention has the multiple protruding ribs. The multiple protruding ribs provide a reaming effect to reduce resistance of discharging the chips after the tip of the screw is screwed into the workpiece. So the chips produced from the workpiece are smoothly discharged from the workpiece.

In addition, an inclined angle of a thread wall of the thread part towards the tip is smaller than an inclined angle of the other thread wall of the thread, so twisting force applied to the tapping process of the screw is reduced and screwing of the screw is laborsaving for users.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of a screw in accordance with the present invention;

FIG. 2 is a side view of the screw in FIG. 1;

FIG. 3 is a cross-sectional side view of the screw along line 3-3 in FIG. 2;

FIG. 4 is an implementing operational view of the screw in FIG. 1, screwed with a workpiece; and

FIG. 5 is another implementing operational view of the screw in FIG. 1, screwed with the workpiece.

### DETAILED DESCRIPTION OF THE PREFERRED EMBODIMENTS

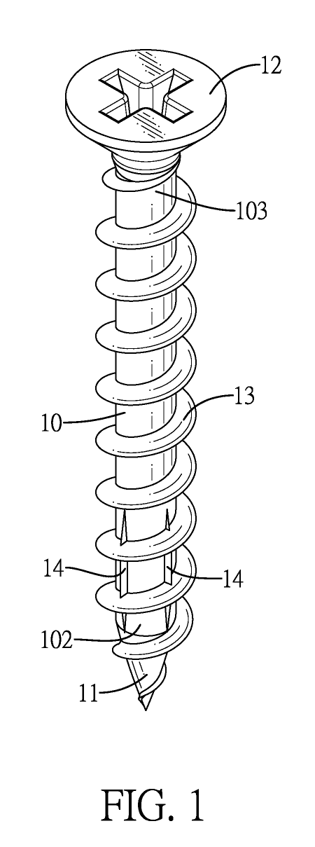

With reference to FIG. 1, an embodiment of a screw in accordance with the present invention comprises a circular rod 10, a tip 11, a tool connecting part 12, a thread part 13, and multiple protruding ribs 14.

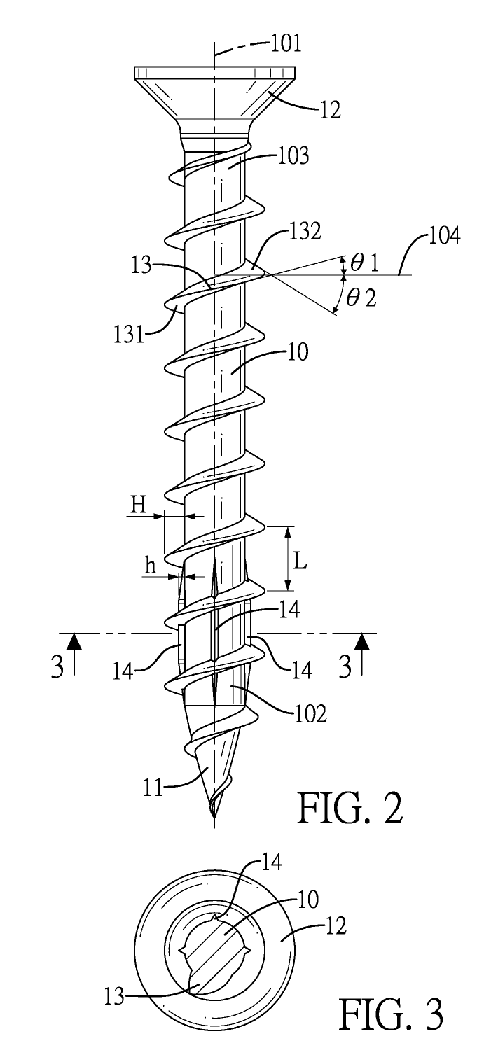

With reference to FIGS. 1 to 2, the circular rod 10 has a centerline 101, a tail end 102, and a head end 103. The tail end 102 and the head end 103 are respectively formed on two ends of the circular rod 10 relative to the centerline 101 of the circular rod 10. The tip 11 is formed on the tail end 102 of the circular rod 10. The tool connecting part 12 is formed on the head end 103 of the circular rod 10 and a diameter of the tool connecting part 12 is bigger than a diameter of the circular rod 10. The tool connecting part 12 has a tool recess formed on a top surface of the tool connecting part 12. In a preferred embodiment, the tool recess is slotted, cross, polygonal or in any other shape for connecting a hand tool or an electric tool. The thread part 13 helically extends from an outer surface of the tip 11 to an outer surface of the circular rod 10.

With reference to FIGS. 1 to 3, the multiple protruding ribs 14 are formed on an outer surface around the tail end 102 of the circular rod 10 and are disposed in multiple thread pitches L of the thread part 13 from the tip 11. The multiple protruding ribs 14 straightly extend on the circular rod 10 and are parallel to the centerline 101 of the circular rod 10. The multiple protruding ribs 14 are two protruding ribs 14 or four protruding ribs 14 formed straightly at equal angles to each other on the circular rod 10. In the preferred embodiment, the multiple protruding ribs 14 are disposed and straightly arranged in a range of two pitches L to four pitches L of the thread part 13 from the tip 11. A rib depth h (the depth that the protruding rib 14 protrudes in a direction of the outer diameter of the circular rod 10) of each protruding rib 14 is smaller than a thread depth H of the thread part 13. In the preferred embodiment, the rib depth h of each protruding rib 14 is from one third to half of the thread depth H.

With reference to FIGS. 1 to 3, the thread part 13 is a V thread and is triangular viewed from the cross section. The thread part 13 has a first thread wall 131 and a second thread wall 132 respectively formed on two sides of the thread part 13. The first thread wall 131 is disposed on a portion of the thread part 13 that is towards the tip 11. The second thread wall 132 is disposed on a portion of the thread part 13 that is towards the tool connecting part 12. In the preferred embodiment, the included angle θ1 between the first thread wall 131 and a perpendicular 104 of the centerline 101 of the circular rod 10 is smaller than the included angle θ2 between the second thread wall 132 and the perpendicular 104 of the centerline 101 of the circular rod 10. The included angle θ1 is an angle of 5 to 20 degrees. The included angle θ2 is an angle of 25 to 45 degrees.

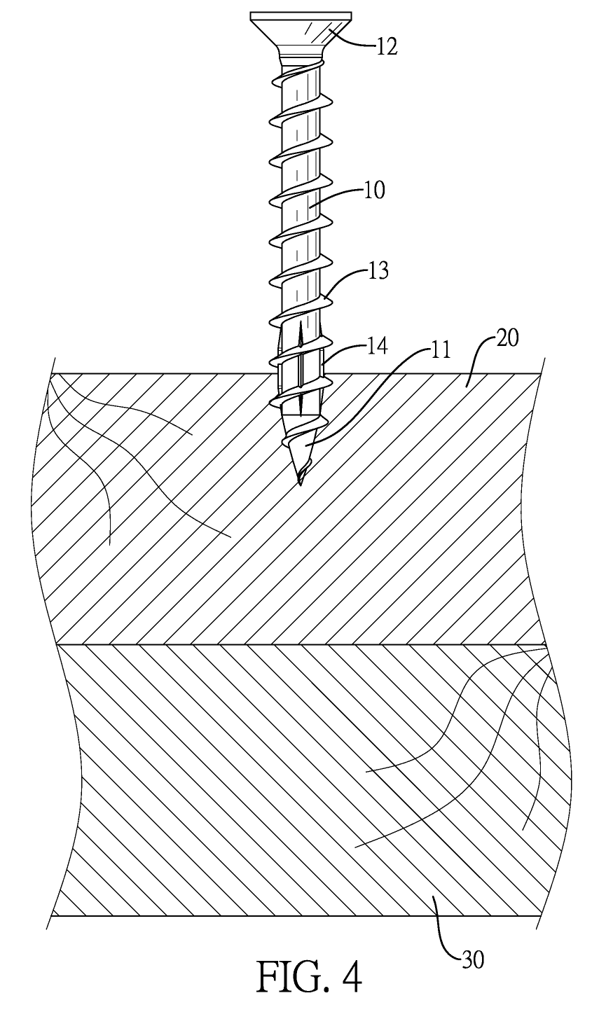

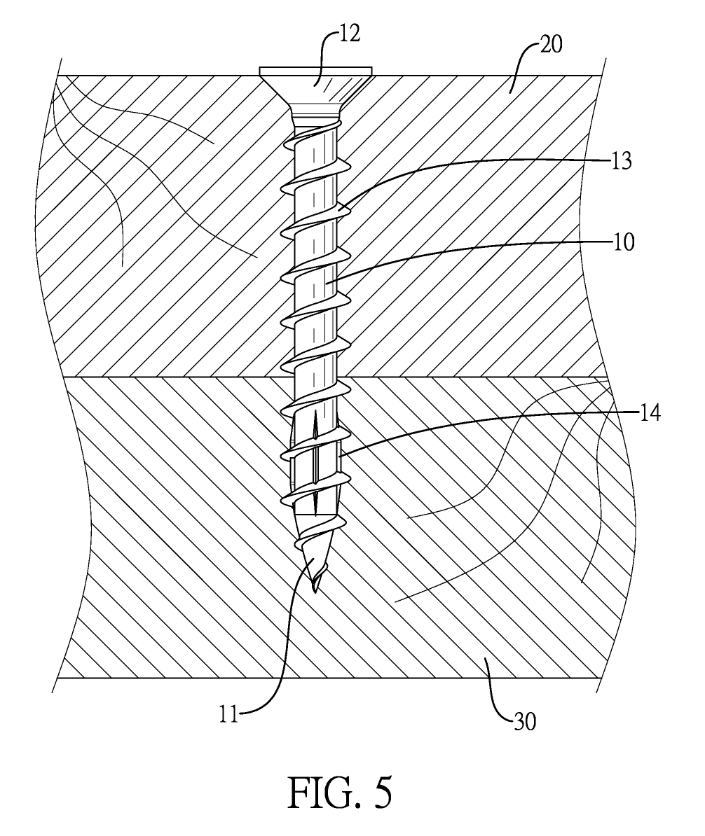

With reference to FIGS. 4 and 5, when the present invention is applied to fasten the workpieces 20, 30, the tool connecting part 12 of the screw is connected to a hand tool or an electric tool by a user, and the screw is rotated by the hand tool or the electric tool. The screw is screwed into the workpieces 20, 30, and the tip 11 and the thread part 13 of the screw start boring a hole and tapping in the workpieces 20, 30. The chips produced from the boring and tapping processes of the screw to the workpieces 20, 30 are discharged along the space formed in the thread part 13 and the circular rod 10. Besides, the multiple protruding ribs 14 provide a reaming effect to reduce resistance of discharging the chips when the tip 11 of the screw is screwed into the workpieces 20, 30. So the chips produced from the workpiece 20, 30 are smoothly discharged from the workpieces 20, 30.

Furthermore, when the screw is screwed into the workpieces 20, 30, an inclined angle of the first thread wall 131 of the thread part 13 towards the tip 11 is smaller than an inclined angle of the second thread wall 132 of the thread 13, thereby reducing twisting force applied to the boring and tapping process of the screw to save labor for user.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A screw comprising:
a circular rod having
a centerline; and
a tail end and a head end respectively formed on two ends of the circular rod relative to the centerline of the circular rod;
a tip formed on the tail end of the circular rod;
a tool connecting part formed on the head end of the circular rod; and
a thread part helically extending from an outer surface of the tip to an outer surface of the circular rod; and
multiple protruding ribs formed on an outer surface around the tail end of the circular rod and disposed in multiple thread pitches of the thread part from the tip, the multiple ribs straightly extending on the circular rod and parallel to the centerline of the circular rod, and a rib depth of each protruding rib being smaller than a thread depth of the thread part.

2. The screw as claimed in claim 1, wherein the multiple protruding ribs are two protruding ribs formed straightly on the circular rod, and the two protruding ribs are disposed in a range of two pitches to four pitches of the thread part from the tip.

3. The screw as claimed in claim 1, wherein the multiple protruding ribs are four protruding ribs formed straightly on the circular rod, and the four protruding ribs are disposed in a range of two pitches to four pitches of the thread part from the tip.

4. The screw as claimed in claim 1, wherein the rib depth of each protruding rib is from one third to half of the thread depth of the thread part.

5. The screw as claimed in claim 2, wherein the rib depth of each protruding rib is from one third to half of the thread depth of the thread part.

6. The screw as claimed in claim 3, wherein the rib depth of each protruding rib is from one third to half of the thread depth of the thread part.

7. The screw as claimed in claim 1, wherein
the thread part is a V thread and has
a first thread wall disposed on the thread part toward the tip; and
a second thread wall disposed on the thread part towards the tool connecting part;
wherein an included angle between the first thread wall and a perpendicular of the centerline of the circular rod is smaller than an included angle between the second thread wall and the perpendicular of the centerline of the circular rod.

8. The screw as claimed in claim 6, wherein
the thread part is a V thread and has
a first thread wall disposed on the thread part towards the tip; and
a second thread wall disposed on the thread part towards the tool connecting part;
wherein an included angle between the first thread wall and a perpendicular of the centerline of the circular rod is smaller than an included angle between the second thread wall and the perpendicular of the centerline of the circular rod.

9. The screw as claimed in claim 7, wherein the included angle between the first thread wall and the perpendicular of the centerline of the circular rod is 5 to 20 degrees, and the included angle between the second thread wall and the perpendicular of the centerline of the circular rod is 25 to 45 degrees.

10. The screw as claimed in claim 8, wherein the included angle between the first thread wall and the perpendicular of the centerline of the circular rod is 5 to 20 degrees, and the included angle between the second thread wall and the perpendicular of the centerline of the circular rod is 25 to 45 degrees.
